(19) United States
(12) Patent Application Publication
(10) Pub. No.: US 2010/0194885 A1
(43) Pub. Date: Aug. 5, 2010

(54) MOTORCYCLE SECURITY SYSTEM AND METHOD THEREFOR

(76) Inventor: Morgan Plaster, Las Vegas, NV (US)

Correspondence Address: WEISS & MOY PC, 4204 NORTH BROWN AVENUE, SCOTTSDALE, AZ, 85251, US

(21) Appl. No.: 12/570,832

(22) Filed: Sep. 30, 2009

Related U.S. Application Data
(63) Continuation-in-part of application No. 12/539,029, filed on Aug. 11, 2009.
Application No. 12/539,029 is a continuation-in-part of application No. 12/364,249, filed on Feb. 2, 2009.

(51) Int. Cl. H04N 7/18; B60R 25/10

(52) U.S. Cl. 348/148; 340/429; 348/E07.085; 455/556.1

(57) ABSTRACT

A security system for an open compartment vehicle has at least one sensor located on the open compartment vehicle. The at least one sensor indicates one of movement of the open compartment vehicle or an object being within a predetermined distance of the open compartment vehicle. At least one camera module is mounted on the open compartment vehicle and positioned to provides real time images of a sitting area of the open compartment vehicle. A transmitter is provided for transmitting the real time video images for viewing at a remote location.

### RELATED APPLICATIONS

The present application is a Continuation-In-Part of U.S. patent application having Ser. No. 12/539,029, filed Aug. 11, 2009, in the name of the same inventor and entitled, “DRIVER OBSERVATION SYSTEM AND METHOD THEREFOR”, which is a Continuation-In-Part of U.S. patent application having Ser. No. 12/364,249, filed Feb. 2, 2009, in the name of the same inventor and entitled, “DRIVER OBSERVATION SYSTEM AND METHOD THEREFOR”. The present application is further related to U.S. Pat. No. 7,380,951, issued on Jun. 3, 2008, in the name of the same inventor, and entitled, “DRIVER OBSERVATION SYSTEM AND METHOD THEREFOR”; and U.S. patent application having Ser. No. 12/186,419, filed Aug. 5, 2008, entitled, “DRIVER OBSERVATION SYSTEM AND METHOD THEREFOR”, in the name of the same inventor. All of the above applications and patents are hereby incorporated herewith.

### FIELD OF THE INVENTION

The present invention relates to automobiles, recreational vehicles (RVs), motorcycles, and the like, and more specifically, to a system for providing security against thief and vandalism to the vehicle.

### BACKGROUND OF THE INVENTION

With the ever increasing number of vehicles on the roads, streets and highways and the increasing number of larger vehicles, such as pick-up trucks, vans and sports utility vehicles, commonly known as SUVs, the ability of the driver of a vehicle, especially smaller vehicles such as sports cars and sedans, to see traffic conditions, whether on the side, in the rear or forward has been diminished. This is particularly so in those conditions where a driver is attempting to turn into an intersecting street, or back out of a parking spot, or trying to turn left from a turning lane across oncoming traffic. In all those instances the driver must extend the vehicle into traffic a sufficient length, usually almost half the length of the vehicle, so that the driver's line of vision covers the oncoming traffic. While most vehicles are equipped with rear view mirrors and there have been attempts to eliminate the “blind spot” behind the driver, the need to extend the driver's line of vision applies in all direction.

Likewise, because so many vehicles are already in use, there is a need to provide an enhancement or extension of the driver's line of vision to existing vehicles as well as those under manufacture. Such an enhancement would have broader application and use if it were relatively small and unobtrusive.

Another common problem with vehicles is theft. According to the Federal Bureau of Investigation's (FBI) Uniform Crime Reports, a motor vehicle is stolen in the United States every 28.8 seconds. The odds of a vehicle being stolen were 1 in 210 in 2006. This number is even higher in urban areas and in southern states that have share a border with Mexico. Car theft costs at least $8.3 billion yearly and accounts for almost half of the total property lost to crime each year. Additionally, approximately $1.0 billion is spent annually in local law enforcement efforts to address car thefts and related crimes

While improvements to vehicle security systems, such as car alarms and ignition and steering wheel locks, have made auto theft more difficult to amateur auto thieves, such devices are of little significance to the professional auto thief. The chance of apprehension, conviction, and imprisonment of an auto thief is less than one percent.

Motorcycles are even a bigger theft issue than automobiles. Motorcycles are easier for a thief to steal than an automobile, this due to the lighter weight and smaller size of these two-wheeled vehicles. As can be appreciated, a thief can make off with a motorcycle by simply standing the bike upright, raising the side stand and just walking the bike down the road.

Conventional means of protecting a motorcycle from theft include the use of a combination or key locking device inserted through the wheel spokes to the frame, as well as ignition keys on motorcycles. Such means are relatively ineffective in providing theft protection.

Therefore, a need exists to provide a device and method to overcome the above problem.

### SUMMARY

In accordance with one embodiment, a driver observation and security system has at least one sensor located on a vehicle. The sensor is used to indicate unauthorized entry into the vehicle. At least one interior camera module is mounted in an interior of the vehicle. The interior camera module provides real time images of the interior of the vehicle when the at least one sensor indicates unauthorized entry into the vehicle. A transmitter is used for transmitting the real time video images for viewing at a remote location. A location unit is located on the vehicle for sending a signal indicating a present location of the vehicle.

In accordance with another embodiment of the present invention, a driver observation and security system has at least one sensor located on a vehicle. The at least one sensor is used to indicate unauthorized entry into the vehicle. At least one interior camera module is mounted in an interior of the vehicle. The at least one interior camera module provides real time images of the interior of the vehicle when the at least one sensor indicates unauthorized entry into the vehicle. A control mechanism is coupled to the at least one interior camera module to control operation of the at least one interior camera module. A recording device is coupled to the control mechanism for storing the real time video images. A transmitter is coupled to the control mechanism for transmitting the real time video images for viewing at a remote location. A location unit is located on the vehicle for sending a signal indicating a present location of the vehicle.

A security system for an open compartment vehicle has at least one sensor located on the open compartment vehicle. The at least one sensor indicates one of movement of the open compartment vehicle or an object being within a predetermined distance of the open compartment vehicle. At least one camera module is mounted on the open compartment vehicle and positioned to provide real time images of a sitting area of the open compartment vehicle. A transmitter is provided for transmitting the real time video images for viewing at a remote location

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is an elevated perspective view of one embodiment of the camera module used in the present invention;

FIG. 2 is front perspective view of a vehicle showing the locations of the camera modules mounted thereon;

FIG. 3 is a magnified front view of the camera system used in the present invention mounted on the vehicle;

FIG. 4 is an elevated perspective view of the dashboard of the vehicle having a camera module and a monitoring and control system used in the present invention;

FIG. 5 is a simplified functional block diagram showing the driver observation system of the present invention;

FIG. 6 is a perspective view of a Recreational Vehicle (RV) encompassing the driver observation system of the present invention;

FIG. 7 is a perspective view of an interior of the RV of FIG. 6;

FIG. 8 is a perspective view of a motorcycle encompassing an alarm system of the present invention; and

FIG. 9 is a simplified functional block diagram of the alarm system of FIG. 8.

### DETAILED DESCRIPTION

Referring to the Figures, a driver observation system 10 is shown. The driver observation system 10 will provide an enhancement or extension of the driver's line of vision to existing vehicles as well as those under manufacture. The driver observation system 10 will increase the line of vision of the driver to extend to all corners of a vehicle. The driver observation system 10 will also serve as a security system for vehicle 22.

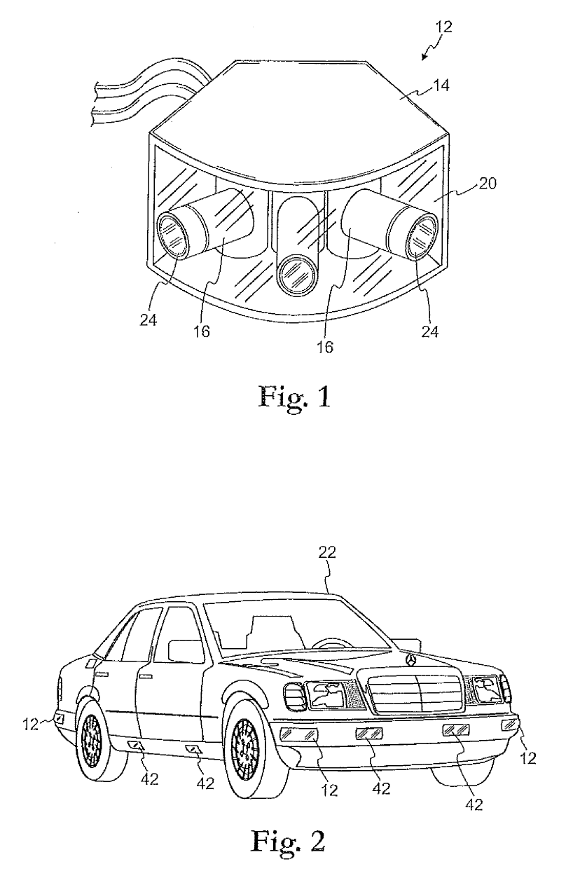

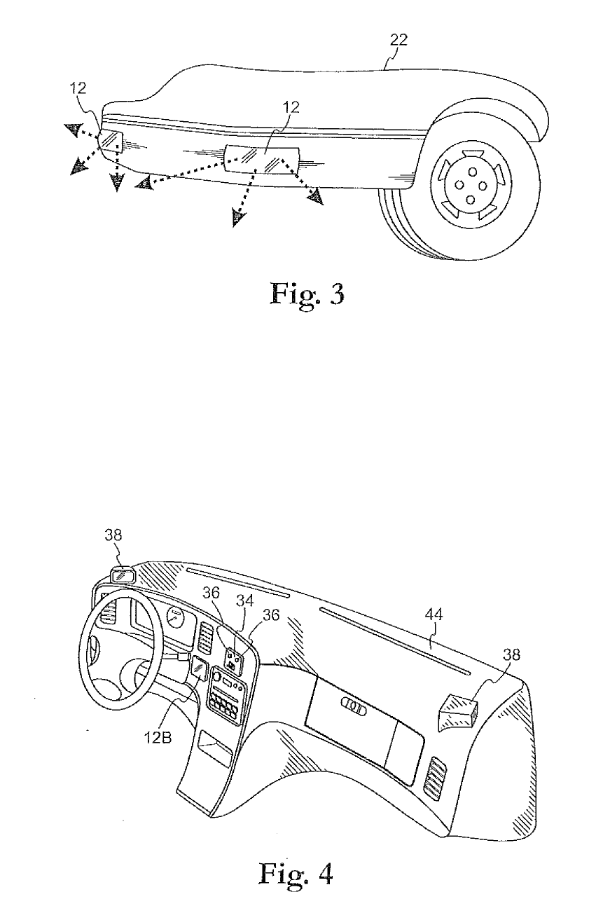

As shown in FIGS. 1-4, the driver observation system 10 has a plurality of camera modules 12. Each camera module 12 is mounted to the vehicle 22. In accordance with one embodiment, the vehicle 22 will have a plurality of external camera modules 12A which are mounted to an exterior surface of the vehicle 22 and at least one interior camera module 12B which is mounted to an interior area of the vehicle 22.

As shown in the Figures, the exterior camera modules 12A are generally mounted in the front and/or rear bumper of the vehicle 22. Preferably, the camera modules 12 are mounted on all four corners of the vehicle 22. For a more aerodynamic look, each camera module 12 is generally mounted inside the bumper of the vehicle 22 with the front face of the camera module 12 flush with the bumper. The above is given as an example. The camera module 12 may be mounted to other components and areas of the vehicle 22 without departing from the spirit and scope of the present invention. For example, the exterior camera modules 12A could be integrated into the existing headlight construction of the vehicle 22.

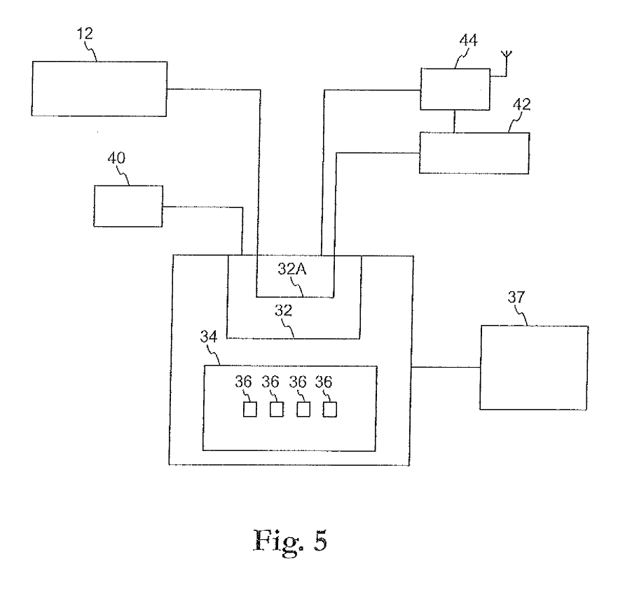

As stated above, at least one camera module 12 is mounted to an interior of the vehicle 22. The interior camera module 12A is generally mounted in a front interior section of the vehicle 22 and will be focused on the passenger area of the vehicle 22. As shown in FIG. 5, in accordance with one embodiment, the interior camera module 12B is mounted in the dashboard 44 of the vehicle 22.

Each camera module 12 will provide a real time video stream of an area in the direction of where the camera module 12 is pointed. By mounting multiple camera modules 12 around the exterior of the vehicle 22, one will increase the line of vision of the driver to extend to different areas of the vehicle 22. Also, the interior camera module 12B allows one to record real time video stream of those in the passenger compartment of the vehicle 22. This data may be used as a safety feature which will be discussed below.

As shown in FIG. 1 each camera module 12, both exterior camera modules 12A and interior camera module 12B, has a housing 14, a plurality of monitoring cameras 16, and a lens panel 20. The housing 14 is generally made of a lightweight but sturdy material such as plastic, aluminum or the like. The listing of the above is given as an example and should not be seen as to limit the scope of the present invention. The housing 14 is used to protect the components in the camera module 12 from damage. The housing 14 shown in the FIG. 1 is slightly conical in shape. However, the housing 14 may come in different shapes without departing from the spirit and scope of the present invention.

As stated above, in FIG. 1, the housing 14 is slightly conical in shape. The housing 14 has a rounded front section. The side walls 14A tapers down as the side walls moves towards the rear of the housing 14. The tapered shape of the housing 14 serves two purposes. First, the rounded front end allows the monitoring cameras 16 to have a wider viewing angle. This will allow the camera modules 12 to have a larger viewing area. The tapered housing 14 further allows one to more easily install the driver observation system 10 in an existing vehicle 22. The tapered rear section of the housing 14 will allow the housing 14 to more easily be positioned inside an existing bumper of a vehicle 22, dashboard, or other exterior/interior area of the vehicle 22.

The rounded front section of the housing 14 is covered by a lens panel 20. The lens panel 20 encloses the housing 14 to prevent damage to the components in the camera module 12. The lens panel 20 further reduces the glare from the sun and other light sources. The lens panel 20 may have a tint, coating, or the like to reduce the glare from different light sources.

Located inside each housing 14 is a plurality of monitoring cameras 16. The monitoring cameras 16 will provide real time video stream of an area where the monitoring camera 16 is pointed. Any type of monitoring camera may be used. In accordance with one embodiment, a fiber optic camera is used as these types of cameras require less space and are easier to conceal. The monitoring camera 16 may have an adjustable lens 24 mounted thereon. The adjustable lens 24 will allow one to magnify or de-magnify (i.e., zoom in or zoom out) to get a clearer image of an area. Alternatively, a wide angle lens may be placed on the monitoring camera 16. A wide angle lens will generate a larger viewing area. Thus, a larger area can be monitored using a wide angle lens.

Each monitoring camera 16 is mounted inside the housing 14. Each monitoring camera 16 is stationary and does not move. Each monitoring camera 16 is mounted so that the combination of monitoring cameras 16 in a respective camera module 12 will provide a continuous field of view for the entire viewing area of the respective camera module 12. Thus, the field of view from each monitoring camera 16 will slight overlap to provide a continuous view with no missing gaps. Also, by providing a continuous view, when the picture from a first monitoring camera 16 is switched to an adjacent monitoring camera 16, it will look like as if a single monitoring camera 16 is panning over. This will be described further below.

Each camera module 12 is coupled to a control mechanism 30. The control mechanism 30 has several purposes. First, the control mechanism 30 allows one to adjust the focus and magnification of each monitoring camera 16. Second, the control mechanism 30 will allow a person to select the number of active monitoring cameras 16 and to switch between different monitoring camera(s) 16 in each camera module 12. Third, the control mechanism will allow one to switch between different camera modules 12. Thus, a driver can select one or more monitoring cameras 16 to be active in each camera module 12, switch between the different monitoring cameras 16 in each camera module 12 as well as switch to a different camera module (i.e., change from the camera module 12 in the front of the vehicle 22 to one in the rear of the vehicle based on the direction the vehicle 22 is traveling). The above listing is given as an example. The control mechanism 30 may perform other features without departing from the sprit and scope of the present invention.

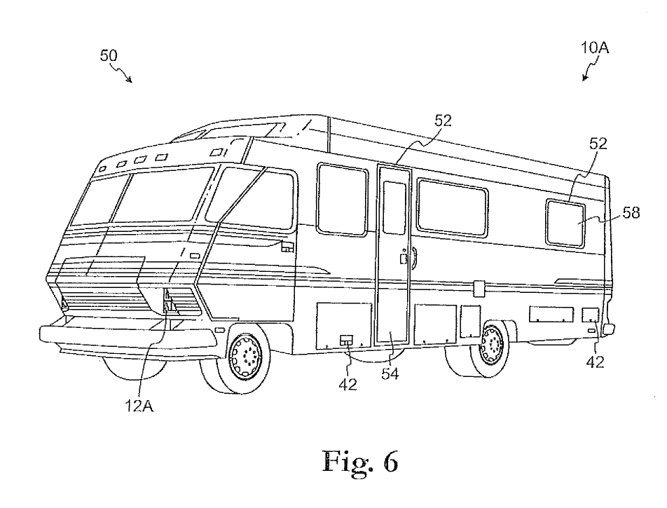

As shown in FIGS. 5 and 6, the control mechanism 30 is comprised of a control circuit 32 and a control panel 34. The control panel 34 is generally mounted in the vehicle 22. As shown in FIG. 5, the control panel 34 has a plurality of input devices 36. The input devices 36 will allow one to control the operation of each camera module 12 and the monitoring cameras 16 in each camera module 12. The input devices 36 will generally be buttons, switches, toggles switches, and the like. The listing of the above is given as examples and should not be seen as to limit the scope of the present invention. The input devices 36 allow one to select the number of monitoring cameras to be active in each camera module 12, switch between different camera modules 12, adjust the focus and/or magnification of the active monitoring camera(s) 16 in each camera module 12, and will allow a person to switch between different monitoring cameras 16 in each camera module 12. The above listing is given as an example. The control mechanism 30 may perform other features without departing from the spirit and scope of the present invention.

The input devices 36 are coupled to the control circuit 32. The control circuit 32 is generally comprised of a processor 32A. The processor 32A is programmed to allow one to adjust the position and focus of each monitoring camera 16 and will allow a person to switch between different monitoring cameras 16 through the use of the input devices 36. The processor 32A further edits the video stream from the different monitoring cameras 16. As stated above, a user may select to have all of the monitoring cameras 16 in a camera module 12 active. Thus, the processor 32A will merge the video stream from each of the active monitoring cameras 16 and form a single video stream that provides a continuous field of view for the entire viewing area of the respective camera module 12. If the user only selects one monitoring camera 16, since the video stream from each monitoring camera 16 will slight overlap, when the video stream from a first monitoring camera 16 is switched to an adjacent monitoring camera 16, the processor will merger the video stream to look as if the video stream is been shifted like the monitoring camera 16 is panning over.

The real time video stream and/or modified video stream by the processor 32A are shown on a display system 37. The display system 37 is generally mounted inside the vehicle 22 in which the driver observation system 10 is installed. In general, the display system 37 is generally comprised of one or more video monitors 38 which are mounted on the dash 44 of the vehicle 22. A video monitor 38 is generally mounted on both the left and right side of the dashboard 44.

The control mechanism 30 may allow one to control the images on the display system 37. For example, the video monitor 38 may be split to show images from all of the camera modules 12. Alternatively, the video monitor 38 may show images from multiple or a single monitoring camera 16. The control mechanism 30 will allow the user to toggle between different monitoring cameras 16 and/or camera modules 12 which will be displayed on the video monitor 38. In accordance with another embodiment, a pair of video monitors 38 may be installed in the vehicle 22. The video monitors 38 will generally be mounted on each side of the dashboard of the vehicle 22. In general, the video monitor 38 on the right side will display images from the front and back of the vehicle 22 on the passenger's side, while video monitor 38 on the left side will display images from the front and back of the vehicle 22 on the driver's side. As discussed above, the video monitors 38 may be split to show images from all of the monitoring cameras 16 and/or camera modules 12. Alternatively, the video monitor 38 may just show images from individual or multiple monitoring cameras 16. The control mechanism 30 will then allow the user to toggle between different monitoring cameras 16 which will be displayed on the video monitor 38.

A recording device 40 may be coupled to the processor 32A. The recording device 40 is used to store the video stream from the monitoring cameras 16 of the different camera modules 12. The recoding device 40 may be programmed to record the video stream from all the camera modules 12, only the active camera modules 12, the video stream that is displayed on the video monitor 38, and the like. The recording device 40 may further be used to record the video stream from the interior camera module 12B. This data may be used as evidence. For example, the recorded video stream may be used to show that the driver was handling the vehicle 22 in a proper manner during an accident, was driving in a proper manner if the vehicle 22 is a company vehicle, and the like. The above listing of the above video stream to be recorded and uses of the recorded video stream data is given as an example and should not be seen as to limit the scope of the present invention. In general, the control mechanism 30 may be used to program the recording device 40 as to which video stream is to be recorded.

The driver observation system 10 may further have proximity sensors 42 located on the vehicle 22. The proximity sensors 42 are used to monitor a perimeter around the vehicle 22. When the vehicle 22 is turned off, the proximity sensors 42 will activate. If a person comes within a predetermined distance of the vehicle 22, the proximity sensor 42 will send a signal to the processor 32A to active the camera module 12 closest to the proximity sensor 42 that was triggered. The interior camera module 12A may also be activated. The monitoring cameras 16 in the activated camera module 12 will send a video stream which will be recorded by the recording device 40. The recorded video stream may be used as evidence. For example, the recorded video stream may be used to identify individuals who may have vandalize the vehicle 22, stolen the vehicle 22, and the like.

A transmitter 44 may be coupled to the recording device 44 and the control circuit 30. The transmitter 42 will compress and transmit the video stream being recorded to a device such as a cellular phone, computer, laptop, personal digital assistant, and the like. Alternatively, the transmitter 42 will compress and transmit the video stream being recorded to a third party monitoring company. The control circuit 30 may be used to program when the transmitter 44 transmits video stream data.

For example, the transmitter 42 may be activated when the proximity sensor 42 sends the signal to the processor 32A to active the camera module 12 closest to the proximity sensor 42 that has been tripped. An individual may receive the video stream in real time, such as on a cellular phone, to monitor the vehicle 22 to make sure no one is trying to steal/damage his vehicle 22. Alternatively, a parent may have video stream data from the interior camera module 12B sent to the parent's cellular phone/computer so that the parent may monitor a child's driving abilities. The listing of the above is only given as examples, and should not be seen as to limit the scope of the present invention. The transmitter 44 may transmit video stream data for many other reasons other than those described above.

The observation system 10 may further have a GPS unit 46. The GPS unit 46 may be coupled to the transmitter 42 or another transmitting antenna. The GPS unit 46 would further aid in vehicle recovery, accident reporting, and navigation.

Referring now to FIGS. 1 and 5-7, another embodiment of the present invention is shown. In this embodiment, the observation system 10A is installed in a recreational vehicle (RV) 50.

In the present embodiment, the observation system 10A may still have a plurality of camera modules 12. Each camera module 12 is mounted to the RV 50. In accordance with one embodiment, the RV 50 may have a plurality of external camera modules 12A which are mounted to an exterior surface of the vehicle 22 and/or at least one interior camera module 12B which is mounted to an interior area 51 of the RV 50.

As in the previous embodiment, the exterior camera modules 12A are generally mounted in the front and/or rear bumper of the RV 50. Each exterior camera module 12A is generally mounted inside the bumper of the RV 50 with the front face of the exterior camera module 12A flush with the bumper. The above is given as an example. The exterior camera module 12A may be mounted to other components and areas of the RV 50 without departing from the spirit and scope of the present invention. For example, the exterior camera modules 12A could be integrated into the existing headlight construction of the RV 50.

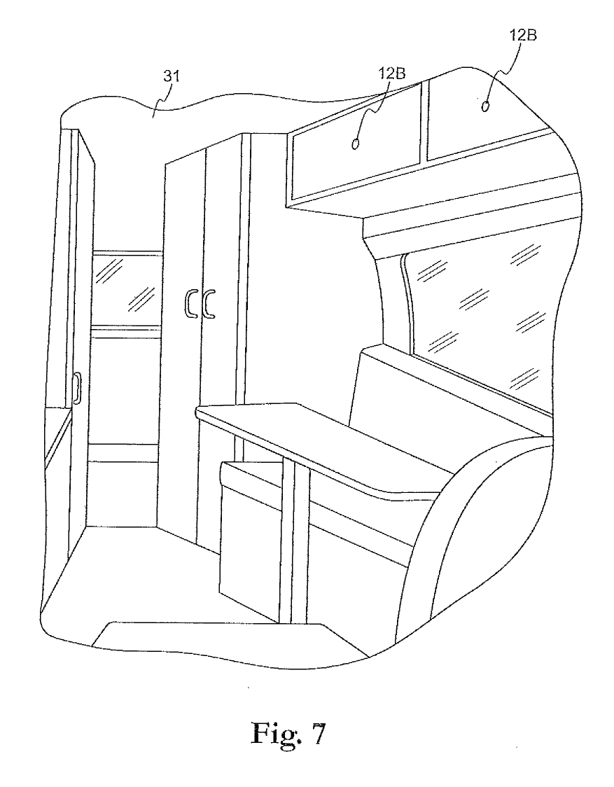

As stated above, at least one camera module 12 is mounted to an interior 51 of the RV 50. The interior camera module 12B is generally mounted to focus on the interior 51 of the RV 50. As shown in FIGS. 6 and 7, in accordance with one embodiment, the interior camera modules 12B are mounted in different areas of the passenger compartment of the RV 50. As in the previous embodiment, interior camera modules 12B may also be installed in the dashboard of the RV 50.

Each camera module 12 will provide a real time video stream of an area in the direction of where the camera module 12 is pointed. By mounting multiple camera modules 12 around the exterior of the RV 50, one will increase the line of vision of the driver to extend to different areas of the RV 50. Also, the interior camera module 12B allows one to record real time video stream of those in the interior 51 of the RV 50. The video stream may be transmitted via wires, fiber optics, wirelessly, or the like. This data may be used as a safety feature which will be discussed below.

As in the previous embodiment, each camera module 12, both exterior camera modules 12A and interior camera module 12B, has a housing 14, a plurality of monitoring cameras 16, and a lens panel 20. The housing 14 is generally made of a lightweight but sturdy material such as plastic, aluminum or the like. The housing 14 is used to protect the components in the camera module 12 from damage.

The housing 14 may be slightly conical in shape. The housing 14 has a rounded front section. The side walls 14A tapers down as the side walls moves towards the rear of the housing 14. The tapered shape of the housing 14 serves two purposes. First, the rounded front end allows the monitoring cameras 16 to have a wider viewing angle. This will allow the camera modules 12 to have a larger viewing area. The tapered housing 14 further allows one to more easily install the driver observation system 10 in an existing RV 50. The tapered rear section of the housing 14 will allow the housing 14 to more easily be positioned inside an existing bumper of an RV 50, dashboard, or other exterior/interior area of the RV 50.

The rounded front section of the housing 14 is covered by a lens panel 20. The lens panel 20 encloses the housing 14 to prevent damage to the components in the camera module 12. The lens panel 20 further reduces the glare from the sun and other light sources. The lens panel 20 may have a tint, coating, or the like to reduce the glare from different light sources.

Located inside each housing 14 is at least one monitoring camera 16. The monitoring cameras 16 will provide real time video stream of an area where the monitoring camera 16 is pointed. Any type of monitoring camera may be used. In accordance with one embodiment, a fiber optic camera is used as these types of cameras require less space and are easier to conceal. The monitoring camera 16 may have an adjustable lens 24 mounted thereon. The adjustable lens 24 will allow one to magnify or de-magnify (i.e., zoom in or zoom out) to get a clearer image of an area. Alternatively, a wide angle lens may be placed on the monitoring camera 16. A wide angle lens will generate a larger viewing area. Thus, a larger area can be monitored using a wide angle lens.

The observation system 10A further has plurality of sensor 52. The sensors 52 may be located on the doors 54 and 56 of the RV 50. Sensors 52 may further be located on certain windows 58 of the RV 50. The sensors 52 will monitor if there is an unauthorized entry into the RV 50 through one of the doors or the windows 58. The observation system 10 may further have sensors 60 located in the interior 51 of the RV 50. The sensors 60 may be active, passive, or software detection sensor devices. The sensors 60 will detect the movement of unauthorized individuals in the RV 50.

In accordance with one embodiment, the sensors 60 are passive sensors such as passive infrared sensors. These types of sensors 60 will lower power consumption of the observation system 10A. Passive sensors may include but are not limited to infrared sensors and the like.

Alternatively, the sensors 60 may be active sensors. Active sensors may include but is not limited to photoelectric beams, microwave detection, radar detection and the like. In an active sensor, the sensor 60 will continuous run. If the sensor detects a person or object in the RV 50, i.e., broken IR beam, radar and or microwave detection, or the like, the active sensor will send a signal indicating unauthorized individuals in the RV 50.

The sensors 60 may further be software detection type sensors. In this type of sensor, the sensor 60 will monitor images in the interior of the RV 50. Software is used to interpret the images. For example, the software may be DVR pixel based motion detection or more advanced software based detection, including but not limited to group pixel and boundary identification, facial recognition, and the like. In group pixel and boundary identification, software groups the pixels together, then, if that pattern crosses a predetermined line the sensor sends an alarm signal. In facial recognition, the software will compare the captured image to those stored. If the image captured is not one of the stored images, the sensor sends an alarm signal. In general, the recording device 40 may be used to store and compare the monitored images for the software detection type sensors.

The sensor 60 may further be sound sensors. The sound sensor will monitor and compare the captured sounds. For example, the sound sensor may be used to detect breaking glass. Alternatively, the sound sensor may capture and compare voices heard in the RV 50. If the voice captured is not identified, the sensor 60 sends an alarm signal. Further, the sound sensors may also be some type of system that allows two way voice or audio confirmation of a crime in progress.

If one of the sensors 52 or sensors 60 detects unauthorized entry into the RV 50, the sensors 52 or sensors 60 that detects the unauthorized entry will send a signal to the interior camera module 12A closest to the sensor 52 or motion sensor 60 that detects the unauthorized entry. The signal may be sent via a wired connection, fiber optic connection, wirelessly, or the like. The interior camera module 12A will begin to record and send the recorded data to the control mechanism 30. The control mechanism may be coupled to the sensors 52 and 56 and to the camera modules 12 via a wired connection, fiber optic connection, wirelessly, or the like.

As shown in FIGS. 5 and 6, the control mechanism 30 may be comprised of a control circuit 32 and a control panel 34. The control panel 34 may generally be mounted in the RV 50. As shown in FIG. 5, the control panel 34 may have a plurality of input devices 36. The input devices 36 allow one to control the operation of each camera module 12 and the monitoring cameras 16 in each camera module 12. The input devices 36 may be buttons, switches, toggles switches, and the like. The input devices 36 allow one to select the number of monitoring cameras 16 to be active in each camera module 12, switch between different camera modules 12, adjust the focus and/or magnification of the active monitoring camera(s) 16 in each camera module 12, and will allow a person to switch between different monitoring cameras 16 in each camera module 12. The above listing is given as an example. The control mechanism 30 may perform other features without departing from the spirit and scope of the present invention.

The input devices 36 may be coupled to the control circuit 32. The control circuit 32 is generally comprised of a processor 32A. The processor 32A is programmed to allow one to adjust the position and focus of each monitoring camera 16 and will allow a person to switch between different monitoring cameras 16 through the use of the input devices 36. The processor 32A further edits the video stream from the different monitoring cameras 16. As stated above, a user may select to have all of the monitoring cameras 16 in a camera module 12 active. Thus, the processor 32A will merge the video stream from each of the active monitoring cameras 16 and form a single video stream that provides a continuous field of view for the entire viewing area of the respective camera module 12. If the user only selects one monitoring camera 16, since the video stream from each monitoring camera 16 will slight overlap, when the video stream from a first monitoring camera 16 is switched to an adjacent monitoring camera 16, the processor will merger the video stream to look as if the video stream is been shifted like the monitoring camera 16 is panning over. The processor 32A will send signals to activate a particular camera module when one of the sensors 52 or motion sensors 60 detects unauthorized entry into the RV 50.

The real time video stream and/or modified video stream by the processor 32A may be shown on a display system 37. The display system 37 is generally mounted inside the RV 50 in which the driver observation system 10A is installed. In general, the display system 37 is generally comprised of one or more video monitors 38 which are mounted on the dash 44 of the RV 50. A video monitor 38 is generally mounted on both the left and right side of the dashboard 44.

The control mechanism 30 may allow one to control the images on the display system 37. For example, the video monitor 38 may be split to show images from all of the camera modules 12. Alternatively, the video monitor 38 may show images from multiple or a single monitoring camera 16. The control mechanism 30 will allow the user to toggle between different monitoring cameras 16 and/or camera modules 12 which will be displayed on the video monitor 38. In accordance with another embodiment, a pair of video monitors 38 may be installed in the RV 50. The video monitors 38 will generally be mounted on each side of the dashboard of the RV 50. In general, the video monitor 38 on the right side will display images from the front and back of the RV 50 on the passenger's side, while video monitor 38 on the left side will display images from the front and back of the RV 50 on the driver's side. As discussed above, the video monitors 38 may be split to show images from all of the monitoring cameras 16 and/or camera modules 12. Alternatively, the video monitor 38 may just show images from individual or multiple monitoring cameras 16. The control mechanism 30 will then allow the user to toggle between different monitoring cameras 16 which will be displayed on the video monitor 38.

A recording device 40 may be coupled to the processor 32A. The recording device 40 is used to store the video stream from the monitoring cameras 16 of the different camera modules 12. The recoding device 40 may be programmed to record the video stream from all the camera modules 12, only the active camera modules 12, the video stream that is displayed on the video monitor 38, and the like. The recording device 40 may further be used to record the video stream from the interior camera module 12B. This data may be used as evidence. For example, the recorded video stream may be used to show data related to an unauthorized person entering into the RV 50, that the driver was handling the RV 50 in a proper manner during an accident, and the like. The above listing of the above video stream to be recorded and uses of the recorded video stream data is given as an example and should not be seen as to limit the scope of the present invention. In general, the control mechanism 30 may be used to program the recording device 40 as to which video stream is to be recorded. The recording device 40 may be a DVR or the like.

The driver observation system 10A may further have proximity sensors 42 located on the RV 50. The proximity sensors 42 are used to monitor a perimeter around the RV 50. The proximity sensors 42 may be a photoelectric beam, motion sensors, infrared sensors, and the like. When the RV 50 is turned off, the proximity sensors 42 will activate. If a person comes within a predetermined distance of the RV 50, the proximity sensor 42 will send a signal either via a wired or wireless means to the processor 32A to active the camera module 12 closest to the proximity sensor 42 that was triggered. The interior camera module 12A may also be activated. The monitoring cameras 16 in the activated camera module 12 will send a video stream which will be recorded by the recording device 40. The recorded video stream may be used as evidence. For example, the recorded video stream may be used to identify individuals who may have vandalize the vehicle 22, stolen the vehicle 22, and the like.

A transmitter 44 may be coupled to the recording device 44 and the control circuit 30. The transmitter 42 will compress and transmit the video stream being recorded to a device such as a cellular phone, computer, laptop, personal digital assistant, and the like. It should be noted that to conserve power, instead of transmitting a video stream, the transmitter 44 may transmit still images that have been captured by the camera modules 12. The transmitter 42 may also compress and transmit the video stream being recorded to a third party monitoring company or to a server where the video may be viewed via a website. The control circuit 30 may be used to program when the transmitter 44 transmits video stream data. For example, the transmitter 42 may be activated when the proximity sensor 42 sends the signal to the processor 32A to active the camera module 12 closest to the proximity sensor 42 that has been tripped. An individual may receive the video stream in real time, such as on a cellular phone, to monitor the vehicle 22 to make sure no one is trying to steal/damage his vehicle 22. Alternatively, a parent may have video stream data from the interior camera module 12B sent to the parent's cellular phone/computer so that the parent may monitor a child's driving abilities. The listing of the above is only given as examples, and should not be seen as to limit the scope of the present invention. The transmitter 44 may transmit video stream data for many other reasons other than those described above.

The transmitter 44 may be a cellular transmitter, a satellite transmitter, broadband, or the like. The above listing is given as an example and should not be seen as to limit the scope of the present invention. It should be noted that a satellite transmitter may allow for broader coverage in areas where cellular transmission may be difficult due to lack of cellular towers. In accordance with one embodiment, the transmitter 44 is a transmitter/receiver. This would allow a person to use a remote device such as a cellular phone to program/control the control circuit 32. For example, a user may be able to push different buttons on his/her cellular phone to change the video stream being received to a different camera module 12.

The observation system 10A may further have a GPS unit 46. The GPS unit 46 may be coupled to the transmitter 42 or another transmitting antenna. The GPS unit 46 would further aid in vehicle recovery, accident reporting, and navigation. The GPS unit 46 may further be used to monitor the unauthorized movement of the vehicle itself. Thus, if the RV 50 is suppose to be located in a storage facility for a set time frame, if the GPS unit 46 sends a signal indicating movement of the RV 50 during this time frame, a signal will be sent of unauthorized movement.

In another embodiment of the present invention, once the system 10A is tripped, the GPS unit 46 is activated. The GPS unit 46 may be activated once a sensor 42, 52, and or 60 is tripped. Alternatively, the GPS unit 62 may be activated by the third party monitoring station. In this embodiment, the transmitter 42 will compress and transmit the video stream being recorded to the third party monitoring company. The third party monitoring company may then send a signal to a transmitter on the GPS unit 62 to activate the GPS unit 62. The third party monitoring company may activate the GPS unit 62 upon video confirmation of a problem. It should be noted that the GPS unit 62.

While the system 10A discloses the use of a GPS unit 62, other locating methods may be used to locate the RV 50. For example, the system 10A may use WiFi hotspot locating techniques. Alternatively, the system 10A may use cellular phone tower triangulation techniques. The above disclose a few different examples of location techniques. However, other techniques may be used without departing from the spirit of the present invention.

In general, the battery 65 of the RV 50 may be used to power the system 10A. However, due to the nature of the system 10A, the power source may be of particular relevance. For instance, on the RV 50 the power supply is crucial, because the RV 50 often sit for long periods of time in the same location for storage. Thus, the battery 65 may be used to run the entire system 10A when the RV 50 is running. However, the security portion of the system 10A may need to run on an alternative power supply.

In accordance with one embodiment, the system 10A conserves power by using passive sensors for the sensors 60 and lithium ion batteries for powering the interior camera modules 12B. However, other power supplies could be used without departing from the spirit and scope of the present invention.

For instance, a solar panel 63 may be used to power certain components of the system 10A. The solar panel 63 makes detection via software possible, because the recording device 40 must consume power to detect intrusions.

Alternatively, a rechargeable battery 67 may be used to power certain components of the system 10A. For example, the rechargeable battery 67 may be used to power the security components of the system 10A. The rechargeable battery 67 may be coupled to the solar panel 63 so that when the RV 50 often sit for long periods of time in the same location for storage, the rechargeable battery 67 will be charged by the solar panel 63. Alternatively, if the RV 50 is parked for storage, the rechargeable battery 67 may be coupled to line power if line power is available. Line power, if available, may further be used to power the system 10A during storage of the RV 50. In accordance with one embodiment, the rechargeable battery 67 may be the battery 65 of the RV 50.

In many jurisdictions, particularly larger metropolitan areas, police will not respond without a confirmation of a crime in progress, this is either a person on the scene reporting the crime, or an audio, or video confirmation. The system 10A provides a video and/or audio confirmation, and makes that dispatch possible. In essence, the combination of these elements, makes it possible for police to respond to an attempted auto theft.

Referring to FIGS. 1 and 8-9, another embodiment of the system 10B is shown. The system 10B is a security system for two wheeled vehicles. The system 10B may provide enhanced security of a two-wheeled vehicle 70 and the like. Although the term “two-wheeled vehicle” is used, it should be understood that the invention may apply to all-terrain vehicles, three-wheeled or four-wheeled motorcycles or scooters, other vehicles lacking a closed interior cabin, and the like.

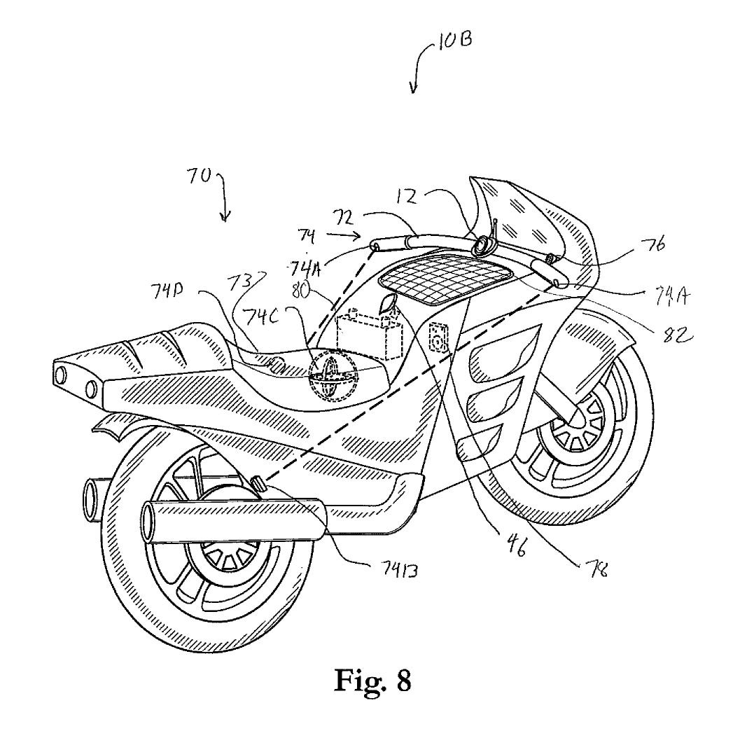

In accordance with one embodiment, the system 10B may have at least one camera module 12. The camera module 12 may be mounted to the two-wheeled vehicle 70. As shown in FIG. 8, the camera module 12 may be mounted in a front area of the two-wheeled vehicle 70 near the steering mechanism 72. The camera module 12 is used to record images. In the embodiment shown in FIG. 8, the camera module 12 is used to record images in front of the steering mechanism 72 near a sitting area 73 of the two-wheeled vehicle 70.

The camera module 12 is similar to that previously described in FIG. 1. As shown in FIG. 1, each camera module 12 may have one or more monitoring cameras 16, and a lens panel 20. The housing 14 is generally made of a lightweight but sturdy material such as plastic, aluminum or the like. The housing 14 may be used to protect the components in the camera module 12 from damage.

The housing 14 may be slightly conical in shape. The housing 14 may have a rounded front section. The side walls 14A may taper down as the side walls move towards the rear of the housing 14. The tapered shape of the housing 14 serves two purposes. First, the rounded front end may allow the monitoring cameras 16 to have a wider viewing angle. This will allow the camera modules 12 to have a larger viewing area. The tapered rear section of the housing 14 may allow the housing 14 to more easily be positioned inside an exterior/interior area of the two-wheeled vehicle 70.

The rounded front section of the housing 14 may be covered by a lens panel 20. The lens panel 20 may enclose the housing 14 to prevent damage to the components in the camera module 12. The lens panel 20 further may reduce the glare from the sun and other light sources. The lens panel 20 may have a tint, coating, or the like to reduce the glare from different light sources.

Located inside each housing 14 is at least one monitoring camera 16. The monitoring cameras 16 may provide real time video stream of an area where the monitoring camera 16 is pointed. Any type of monitoring camera may be used. In accordance with one embodiment, a fiber optic camera is used as these types of cameras require less space and are easier to conceal. The monitoring camera 16 may have an adjustable lens 24 mounted thereon. The adjustable lens 24 will allow one to magnify or de-magnify (i.e., zoom in or zoom out) to get a clearer image of an area. Alternatively, a wide angle lens may be placed on the monitoring camera 16. A wide angle lens will generate a larger viewing area. Thus, a larger area can be monitored using a wide angle lens.

The two-wheeled vehicle 70 may have at least one sensor 74 mounted to the two-wheeled vehicle 22. The at least one sensor 74 may be used to monitor a perimeter around the two-wheeled vehicle 70 and/or to monitor movement of the two-wheeled vehicle 70. The at least one sensor 74 may be a photoelectric beam sensor, a motion detector, tilt sensors, software detection sensor, or the like. If a plurality of sensors 74 are used, the sensors 74 may be a combination of the above mentioned.

If sensor 74 is a photoelectric bean sensor, the photoelectric beam sensor may have a transmitter unit 74A which may be positioned near the steering mechanism 72 and a receiving and or reflecting unit 74B which may be located near a rear portion of the two-wheeled vehicle 70. However, the above is given as an example, and should not be seen to limit the scope of the present invention. The transmitting unit 74A will transmit a light beam to the receiving and or reflecting unit 74B. An object is sensed when the light beam is interrupted and fails to reach the receiving and or reflecting unit 74B or fails to be reflected back to the transmitter unit 74A.

The sensors 74 may further be software detection type sensors. In this type of sensor, the sensor 74 works with the camera modules 12. The camera modules 12 will monitor images around the sitting area 73 of the two-wheeled vehicle 70. Software is used to interpret the images. For example, the software may be DVR pixel based motion detection or more advanced software based detection, including but not limited to group pixel and boundary identification, facial recognition, and the like. In group pixel and boundary identification, software groups the pixels together, then, if that pattern crosses a predetermined line the sensor sends an alarm signal. In facial recognition, the software will compare the captured image to those stored. If the image captured is not one of the stored images, the sensor 74 sends an alarm signal. In general, a recording device 78 may be used to store and compare the monitored images for the software detection type sensors.

The sensor 74 may also be a motion detector or tilt sensor. In accordance with one embodiment, the system 10B may use a gyroscope 74C as a sensor 74. The gyroscope 74C may be coupled to the two-wheeled vehicle 70. The gyroscope 74C may be hidden from view, although this is only an example, and should not be seen as to limit the scope of the present invention. The gyroscope 74C may be capable of detecting movement of the two-wheeled vehicle 70. When the two-wheeled vehicle 70 is turned off, the gyroscope 74C may be activated. The gyroscope 74C may be used to detect movement or tilting of the two-wheeled vehicle 70 such as unauthorized movement of the two-wheeled vehicle 70.

The sensor 74 may further be a pressure sensor 74D. The pressure sensor 74D may be positioned under the sitting area 73. The pressure sensor 74D will monitor if someone is sitting on the sitting area 73 when the system 10 is activated.

When the two-wheeled vehicle 70 is turned off, the at least one sensor 74 may be activated. If a person comes within a predetermined distance of the two-wheeled vehicle 70, or moves or sits on the two-wheeled vehicle 70, the at least one sensor 74 may active one or more camera modules 12. The one or more camera modules 12 activated may be a camera module 12 closest to the sensor 74 that was triggered. The monitoring camera or cameras 16 in the activated camera module 12 may send images which may be used as evidence. The images may be sent to a third party monitoring station, an owner's cellular phone/computer, or the like. The images may be used to identify individuals who may have vandalized the two-wheeled vehicle 70, stolen the two-wheeled vehicle 70, or the like.

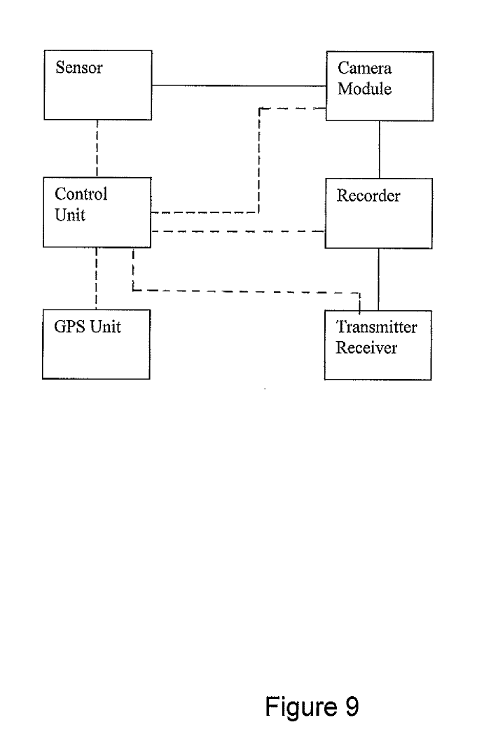

The system 10B may have a GPS unit 46. The GPS unit 46 may be coupled to the transmitter 42 (FIG. 9) or another transmitting antenna. The GPS unit 46 would further aid in vehicle recovery, accident reporting, and navigation. The GPS unit 46 may further be used to monitor the unauthorized movement of the vehicle itself. Thus, if the two-wheeled vehicle 70 is suppose to be parked in a particular location for a set time frame (i.e., at a parking garage for work for 8 hours, or a storage facility), if the GPS unit 46 sends a signal indicating movement of the two-wheeled vehicle 70 during this time frame, a signal will be sent of unauthorized movement.

In another embodiment of the present invention, once the system 10B is tripped, the GPS unit 46 is activated. The GPS unit 46 may be activated once a sensor 74 is tripped. Alternatively, the GPS unit 46 may be activated by a third party monitoring station as previously disclosed. In this embodiment, the transmitter 42 will compress and transmit the video stream being recorded from one of the activated camera module 12 and send the compressed video stream to a third party monitoring company. The third party monitoring company may then send a signal to a transmitter on the GPS unit 46 to activate the GPS unit 46. The third party monitoring company may activate the GPS unit 46 upon video confirmation of a problem. While the system 10B discloses the use of a GPS unit 46, other locating methods may be used to locate the two-wheeled vehicle 70. For example, the system 10B may use WiFi hotspot locating techniques. Alternatively, the system 10B may use cellular phone tower triangulation techniques. The above disclose a few different examples of location techniques. However, other techniques may be used without departing from the spirit of the present invention.

The system 10B may have a speaker 76 coupled to the two-wheeled vehicle 70. The speaker 76 may be part of an existing sound system of the two-wheeled vehicle 70. Alternatively, the speaker 76 may be added feature to the two-wheeled vehicle 70. The speaker 76 may be used to produce an audible signal when a sensor 74 detects unauthorized proximity to, or unauthorized movement of, the two-wheeled vehicle 70. The audible signal may be used to alert people nearby that the two-wheeled vehicle 70 may be being vandalized or stolen, and may also thereby scare off the would-be thief or vandal. In accordance with another embodiment, a microphone may be coupled to the existing sound system of the two-wheeled vehicle 70. The microphone may allow two way communication and may allow a third party monitoring company to talk with individuals around the two-wheeled vehicle 70.

The system 10B may have a recording device 78. The recording device 78 may be coupled to the at least one camera module 12. The recording device 78 may be used for the purpose of recording images captured by the at least one camera module 12. The recording device 78 may be a standard computer hard drive, DVR, or the like. The above is given as an example and should not be seen as to limit the scope of the present invention.

The system 10B may be powered by one or more battery units 80. The battery unit 80 may be the battery of the two-wheeled vehicle 70. Alternatively, the battery unit 80 may be an added battery unit to the two-wheeled vehicle 70. Further, one or more of the components of the system 10B may be individually powered by a battery unit 80.

Alternatively, the battery unit 80 may be a rechargeable battery. The battery unit 80 may be charged when the two-wheeled vehicle 70 is running. Alternatively, the rechargeable battery unit 80 may be coupled to a solar panel 82 for charging.

In accordance with one embodiment, the system 10B conserves power by using passive sensors for the sensors 74 and lithium ion batteries for powering the camera modules 12. However, other power supplies could be used without departing from the spirit and scope of the present invention.

Referring now to FIG. 9, a simplified block diagram of the system 108 is shown. The system 10B will have one or more sensors 74. In accordance with one embodiment, the system 10B has a plurality of sensors 70. The sensors 70 may be active sensors or passive sensors. In accordance with one embodiment, the sensors 70 are passive sensors to conserve power.

In accordance with one embodiment, the sensor 70 is coupled to a camera module 12. When the sensor 70 is tripped, the sensor 70 may active one or more of the camera modules 12. The monitoring camera or cameras 16 in the activated camera module 12 may send data images to the recording device 78. The recording device 78 may be coupled to a transmitter/receiver device 84. The transmitter/receiver device 84 may be used to compress and transmit the data images being recorded to a device such as a cellular phone, computer, laptop, personal digital assistant, and the like. Alternatively, the transmitter/receiver device 84 will compress and transmit the video stream being recorded to a third party monitoring company.

Alternatively, the sensor 70 may be coupled to a control unit 86. The control unit 86 is then coupled to the camera modules 12. The control unit 86 is used to activate and control the camera module 12. In this embodiment, the monitoring camera or cameras 16 in the activated camera module may send data images to the recording device 78. The transmitter/receiver device 84 may be used to compress and transmit the data images being recorded to a device such as a cellular phone, computer, laptop, personal digital assistant, and the like. Alternatively, the transmitter/receiver device 84 will compress and transmit the video stream being recorded to a third party monitoring company. In this embodiment, the transmitter/receiver device 84 may be coupled to the control unit 86. This will a third party to send a signal to the transmitter/receiver device 84 which may then be sent to the control unit 86 to control a desired camera module 12.

While embodiments of the disclosure have been described in terms of various specific embodiments, those skilled in the art will recognize that the embodiments of the disclosure can be practiced with modifications within the spirit and scope of the claims.

What is claimed is:

1. A security system for an open compartment vehicle comprising:
at least one sensor located on the open compartment vehicle, the at least one sensor indicating one of movement of the open compartment vehicle or an object being within a predetermined distance of the open compartment vehicle;
at least one camera module mounted on the open compartment vehicle and positioned to provides real time images of a sitting area of the open compartment vehicle; and
a transmitter for transmitting the real time video images for viewing at a remote location.

2. A driver observation and security system in accordance with claim 1 further comprising a location unit located on the vehicle for sending a signal indicating a present location of the vehicle.

3. A driver observation and security system in accordance with claim 1 further comprising a recording device coupled to the at least one camera module for storing the real time video images.

4. A driver observation and security system in accordance with claim 2 wherein the location unit is activated by one of the at least one sensor being tripped, by a remote source sending a signal to the location unit, or by movement monitored by the location unit.

5. A driver observation and security system in accordance with claim 1 further comprising a rechargeable battery for powering the system.

6. A driver observation and security system in accordance with claim 5 further comprising a solar panel attached to the rechargeable battery for charging the rechargeable battery.

7. A driver observation and security system in accordance with claim 1 wherein the at least one camera module is powered by a lithium battery.

8. A driver observation and security system in accordance claim 1 wherein the at least one sensor is one of a passive detection sensor, an active detection sensors, a software detection device, a voice detection device, or a location detection device.

9. A driver observation and security system in accordance with claim 2 wherein the location unit is one of a GPS unit, a WiFi hotspot location unit, or a cellular transmitter.

10. A driver observation system in accordance with claim 1 further comprising a plurality of sensors, the plurality of sensors comprising photoelectric beam sensors to indicate when an object gets within a predetermined distance of the open compartment vehicle.

11. A driver observation system in accordance with claim 1 further comprising a plurality of sensors, the plurality of sensors comprising at least one gyroscope sensor to indicate movement of the open compartment vehicle.

12. A security system for an open compartment vehicle comprising:
a plurality of sensors located on the open compartment vehicle, the sensors indicating one of movement of the open compartment vehicle or an object being within a predetermined distance of the open compartment vehicle;
at least one camera module mounted on the open compartment vehicle and positioned to provides real time images of a sitting area of the open compartment vehicle;
a recording device coupled to the at least one camera module for storing the real time video images;
a location unit located on the vehicle for sending a signal indicating a present location of the vehicle; and
a transmitter coupled to the recording device for transmitting the real time video images for viewing at a remote location.

13. A driver observation and security system in accordance with claim 12 further comprising a control unit coupled to the plurality of sensors, the at least one camera module, and the recording device.

14. A driver observation and security system in accordance with claim 12 wherein the location unit is activated when one of at least one of the sensors is tripped or a remote source sending a signal to the location unit.

15. A driver observation and security system in accordance with claim 12 further comprising a rechargeable battery for powering the system.

16. A driver observation system in accordance with claim 11 wherein the plurality of sensors comprises at least one photoelectric beam sensor to indicate when an object gets within a predetermined distance of the open compartment vehicle.

17. A driver observation system in accordance with claim 16 wherein the plurality of sensors further comprises at least one gyroscope sensor to indicate movement of the open compartment vehicle.

18. A security system for an open compartment vehicle comprising:
a plurality of sensors located on the open compartment vehicle, the plurality of sensors comprising:
a plurality of photoelectric beam sensors to indicate when an object gets within a predetermined distance of the open compartment vehicle; and
at least one position sensor to indicate movement of the open compartment vehicle;
at least one camera module mounted on the open compartment vehicle and positioned to provides real time images of a sitting area of the open compartment vehicle;
a recording device coupled to the at least one camera module for storing the real time video images;
a location unit located on the vehicle for sending a signal indicating a present location of the vehicle;
a transmitter coupled to the recording device for transmitting the real time video images for viewing at a remote location;
a control unit coupled to the plurality of sensors, the at least one camera module, and the recording device.

19. A driver observation and security system in accordance with claim 18 wherein the location unit is activated when one of at least one of the sensors is tripped or a remote source sending a signal to the location unit.

20. A driver observation and security system in accordance with claim 18 further comprising a rechargeable battery for powering the system.
